(19) United States
(12) Patent Application Publication
(10) Pub. No.: US 2008/0270596 A1
(43) Pub. Date: Oct. 30, 2008

(54) System and method for validating directory replication

(76) Inventor: Mark Frederick Wahl, Austin, TX (US)

Correspondence Address: Mark Wahl, PO Box 90626, Austin, TX, 78709, US

(21) Appl. No.: 11/789,481

(22) Filed: Apr. 25, 2007

(51) Int. Cl. H04L 12/26

(52) U.S. Cl. 709/224

(57) ABSTRACT

A distributed information processing system comprising a collection of servers providing a directory service is augmented with the ability to validate whether replication is occurring between these directory servers.

### FEDERALLY SPONSORED RESEARCH

Not applicable

### SEQUENCE LISTING OR PROGRAM Not applicable

### BACKGROUND OF THE INVENTION

1. Field of Invention

This invention relates generally to the management of directory servers in enterprise computer networks.

2. Prior Art

A typical identity management deployment for an organization will incorporate a directory service. In a typical directory service, one or more server computers host instances of directory server software. These directory servers implement the server side of a directory access protocol, such as the X.500 Directory Access Protocol, as defined in ITU-T Rec. X.519 Information technology—Open Systems Interconnection—The Directory: Protocol specifications, or the Lightweight Directory Access Protocol (LDAP), as defined in Internet RFC 2251 Lightweight Directory Access Protocol (v3), by M. Wahl et al of December 1997. The client side of the directory access protocol is implemented in other components of the identity management deployment, such as an identity manager or access manager.

In order to provide an anticipated level of availability or performance from the directory service when deployed on server computer hardware and directory server software with limits in anticipated uptime and performance, the directory service often will have a replicated topology. In a replicated topology, there are multiple directory servers present in the deployment to provide the directory service, and each directory server holds a replica (a copy) of each element of directory information. One advantage of a replicated topology in an identity management deployment is that even if one directory server is down or unreachable, other directory servers in the deployment will be able to provide the directory service to other components of the identity management deployment. Another advantage is that directory service query operations in the directory access protocol can be processed in parallel in a replicated topology: some clients can send queries to one directory server, and other clients can send queries to other directory servers.

Some directory server implementations which support the X.500 Directory Access Protocol also support the X.500 Directory Information Shadowing Protocol (DISP), as defined in ITU-T Rec. X.519, Information technology—Open Systems Interconnection—The Directory: Protocol specifications, which specifies the procedures for replication between directory servers based on X.500 protocols.

In many large and multinational enterprises, the deployment might incorporate multiple distinct implementations of a directory server, and there may be directory server implementations that are not based on the X.500 protocols. Examples of directory server implementations that are not based on the X.500 protocols include the Microsoft Active Directory, the Sun Java Enterprise System Directory Server, OpenLDAP directory server, and the Novell eDirectory Server. As there is currently no standard replication protocol between directory server implementations from different vendors that are not both implementing the X.500 protocols, synchronization mechanisms are often used in addition to replication protocols in order to maintain the consistency of directory information between directory servers in the deployment. Synchronization products, such as a metadirectory server, are used in enterprise identity management deployments that incorporate directory server implementations from multiple vendors. These synchronization products interconnect these directory servers, and transfer changes made in one directory server to another directory server, so that all directory servers have copies of the data.

In an identity management deployment, failure of any particular server computer system, directory server software, metadirectory software, or network link supporting the deployment can cause the deployment to be partitioned, and the directory servers and metadirectory servers in this situation are no longer able to maintain consistency of the directory contents among all the servers. In a scenario in which a component of the deployment has become unavailable, one set of directory servers might have more recent directory data, incorporating changes that have not been sent to another set of directory servers.

If a directory server is under heavy load from directory clients or from other applications running on the same computer system, it may not be able to keep up with the flow of replication data in the replication protocols. In a scenario in which a directory server which accepts changes from directory clients is under load, that directory server may not be able to send out changes to other directory servers or to a metadirectory server as fast as it is able to process incoming changes from directory clients. In a scenario in which a directory server which accepts changes from other servers in a replication protocol or from a metadirectory server is under load, that directory server may not be able to accept incoming changes from other directory servers or metadirectory servers, and may cause these other servers to hold pending changes destined for that server.

While some directory server products implement a means for an administrator to monitor the replication status of a particular server or the status of consistency between a pair of servers, few directory server products have a means of reporting on the replication consistency state of the entire set of directory servers of that vendor in a particular deployment. Furthermore, a means for monitoring replication status that is tied to a particular directory server's implementation of a replication protocol would not take into account changes made by directory servers from another implementation that are incorporated into the directory service deployment through a metadirectory.

### SUMMARY

This invention defines and implements a method for validating that directory replication is being performed between directory servers in an enterprise identity management deployment.

### OBJECTS AND ADVANTAGES

It is an advantage of this invention over prior art systems in which directory servers generate events to a directory client when replication of a change made by that client occurs, in that the method described in this invention will provide notice to the administrator of the deployment when there is a problem with replication, even if there is no directory client that is making use of the directory service at the time.

It is an advantage of this invention over prior art systems in which directory servers periodically report events indicating that they are alive to a central component, as a directory server may be alive and reachable, but due to a network partition, or a server elsewhere in the network being unavailable, may not be capable of participating in replication, and may have out of date content in its directory.

### DRAWINGS—FIGURES

FIG. 1 is a diagram illustrating a possible deployment of the replication validator described in this invention.

FIG. 2 is a flowchart of the primary thread of control within the replication validator.

FIG. 3 is a flowchart of a processing thread within the replication validator.

FIG. 4 is a flowchart of an observing thread within the replication validator.

FIG. 5, FIG. 6 and FIG. 7 are diagrams illustrating the tables of the database (29).

FIG. 8 is a diagram illustrating the typical components of an enterprise network and computer systems of an identity management deployment that spans multiple physical locations.

FIG. 9 is a diagram illustrating the typical components of a server computer.

FIG. 10 is a diagram illustrating the typical components of a workstation computer.

FIG. 11 is a diagram illustrating a possible deployment of the replication validator described in this invention, in which a metadirectory server is also present in the deployment.

### DRAWINGS—REFERENCE NUMERALS

10—updatable directory server
11—directory client
12—updatable directory server
14—read-only directory server
16—read-only directory server
18—replication communication between directory servers 10 and 12
20—replication communication between directory servers 10 and 14
22—replication communication between directory servers 12 and 16
24—replication communication between directory servers 12 and 14
26—replication communication between directory servers 10 and 16
28—replication validator
29—database
30—communication from replication validator to directory server
31—administrator
32—communication from replication validator to directory server
34—communication from replication validator to directory server
36—communication from replication validator to directory server
37—administrator interface
110—namespace table
112—server table
114—update table
116—template table
118—observation table
120—mapping table
122—observation status table
124—server status table
126—name table
130—application server computer
132—directory server computer
134—administrator workstation computer
136—validator computer
138—local area network (LAN) switch
140—router
142—wide area network (WAN)
144—router
146—local area network (LAN) switch
148—directory server computer
150—directory server computer
152—metadirectory server computer
160—server computer
162—central processing unit (CPU)
164—system bus
166—hard disk interface
168—hard disk
170—operating system (OS) software and configuration stored on the hard disk
172—application software and configuration stored on the hard disk
174—BIOS ROM
176—random access memory (RAM)
178—operating system software, configuration and state in memory
180—application software, configuration and state in memory
182—network interface
184—LAN switch
200—workstation computer
202—central processing unit (CPU)
204—system bus
206—network interface
208—video interface
210—monitor
212—hard disk interface
214—hard disk
216—operating system (OS) software and configuration stored on the hard disk
218—application software and configuration stored on the hard disk
220—universal serial bus (USB) interface
222—keyboard
224—mouse
226—BIOS ROM
228—random access memory (RAM)
230—operating system software, configuration and state in memory
232—application software, configuration and state in memory
234—LAN switch
240—directory client
242—directory server
244—directory server
246—metadirectory server
248—directory server
250—directory server
252—replication validator
254—database
256—administrator interface
258—administrator

### DETAILED DESCRIPTION

The invention comprises the following components:
a directory client (11, 240), a software component of the enterprise identity management deployment that relies upon the directory service,
two or more directory servers (10, 12, 14, 16, 242, 244, 248 and 250) that replicate between themselves, or have their contents synchronized through a metadirectory server,
a replication validator component (28, 252) that establishes connections to each directory server in the deployment,
a database component (29, 254) that stores the persistent configuration state of the replication validator component,
an administrator interface (37, 256) that enables an administrator (31, 258) of the enterprise identity management deployment to be notified of replication failures, and
optionally, a metadirectory server (246) that synchronizes the contents of two or more directory servers that do not replicate to each other.

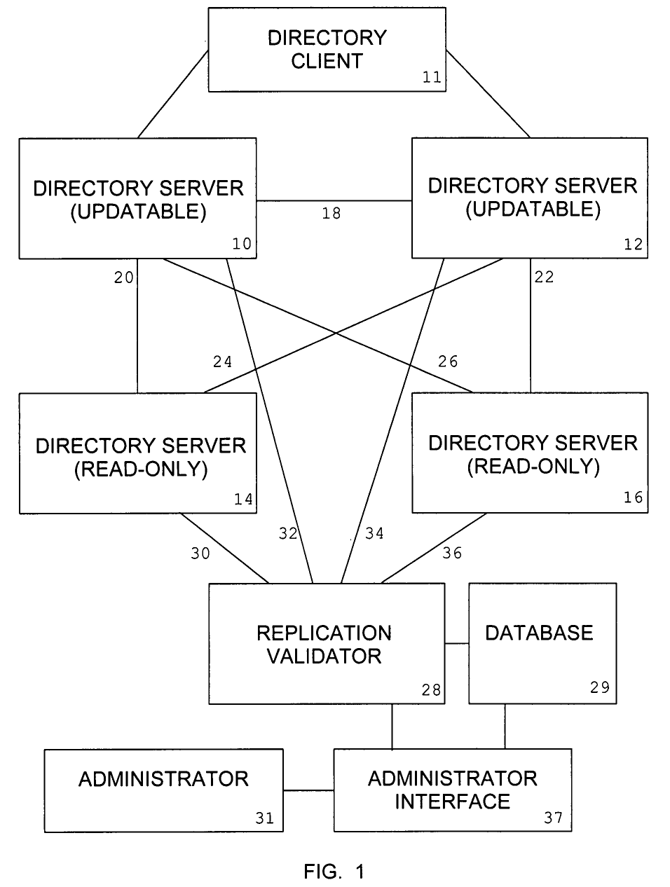

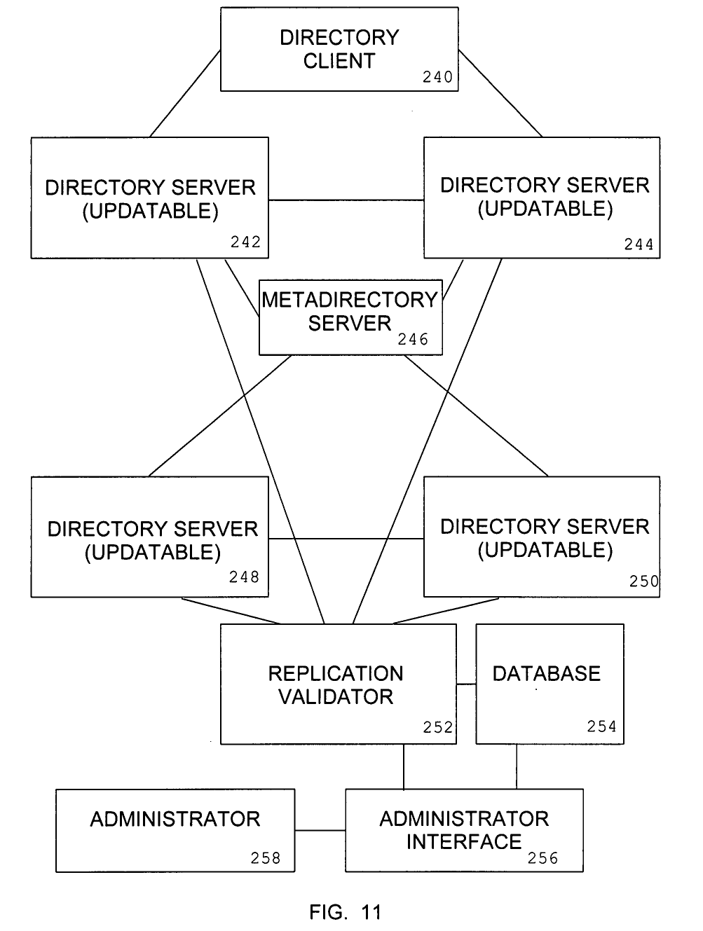

One possible enterprise identity management deployment is illustrated in FIG. 1, in which there are two directory servers that are updatable (e.g., they can accept changes from directory clients, including the replication validator), and two directory servers that are read-only (e.g., they only accept changes from other directory servers, and not from directory clients). Another possible enterprise identity management deployment is illustrated in FIG. 11, in which a metadirectory performs synchronization of the directory contents between the directory servers of one implementation (242, 244) and the directory servers of another implementation (248, 250). There are many other possible deployments for the replication between directory servers, including, for example, having only two directory servers, having all the directory servers be updatable, or having a meta-directory interconnecting additional sets of directory servers.

The directory server (10, 12, 14, 16, 242, 244, 248, 250) is a software component that maintains an internal database of directory entries, and implements the server side of a directory access protocol, such as the X.500 Directory Access Protocol or LDAP. Examples of implementations of directory servers include Microsoft Active Directory, the Sun Java Enterprise System Directory Server, OpenLDAP directory server, and the Novell eDirectory Server.

The replication validator component (28) is a software component that will contact each of the directory servers and validate that directory replication is occurring.

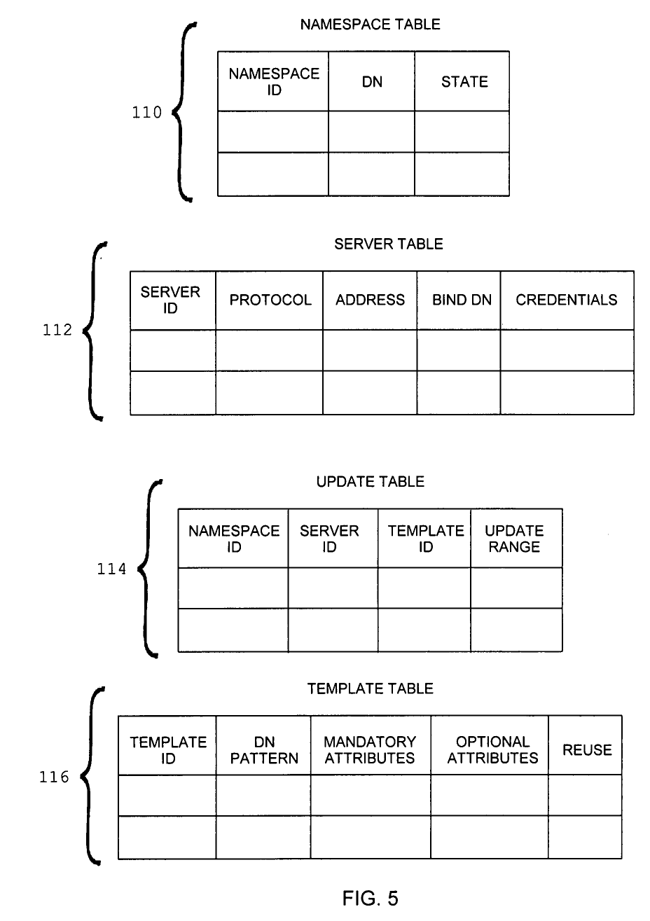

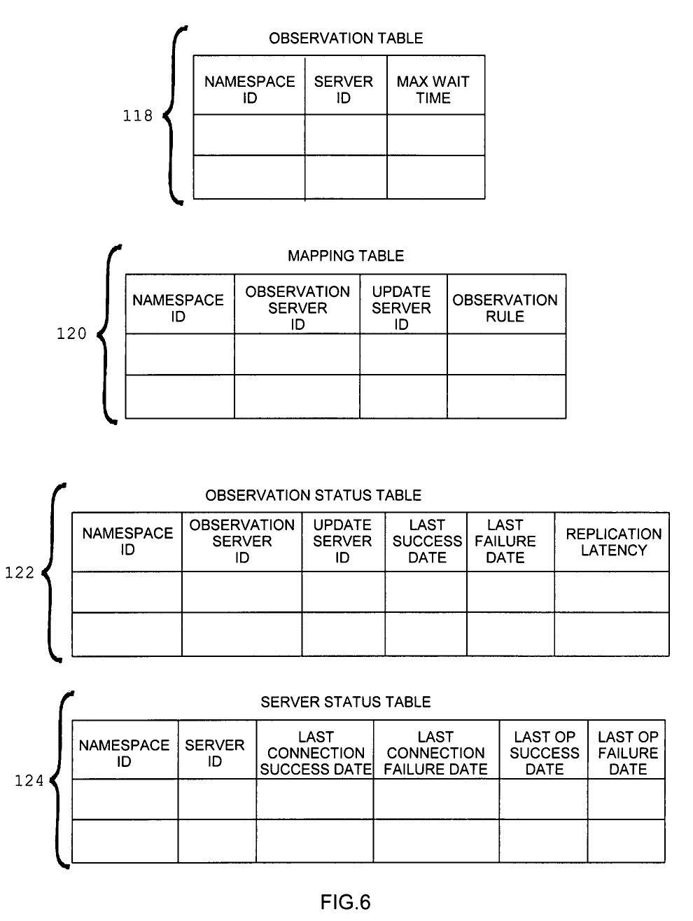

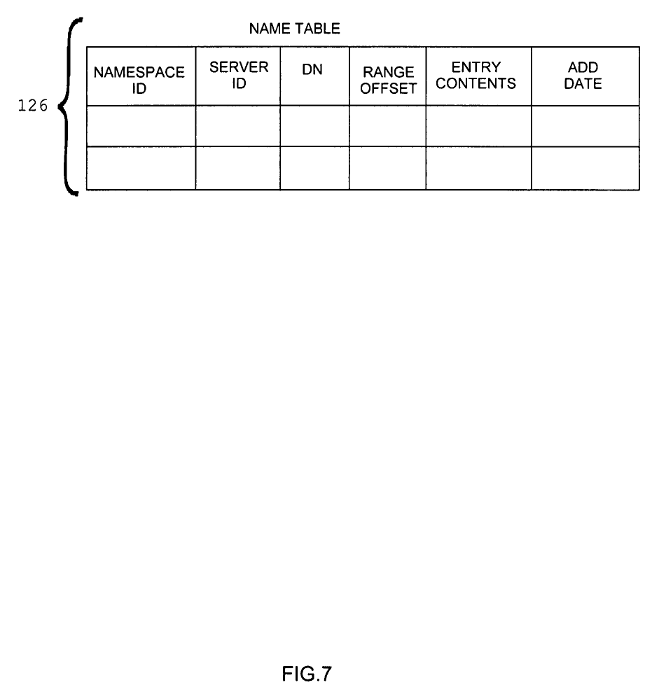

The database component (29) is a software component that maintains the persistent state of the replication validator component. The database component can be implemented as a relational database, which maintains the tables illustrated in FIG. 5, FIG. 6 and FIG. 7.

The replication validator is configured with a list of one or more namespaces. There is one row in the namespace table (110) in the database (29) for each namespace. Each namespace indicates a branch of the directory tree, for example in an LDAP directory a branch might correspond to the subtree used by the organization to contain entries representing people and computer accounts. The primary key of this table is the NAMESPACE ID column. The columns of this table are:
NAMESPACE ID: a unique identifier for the namespace,
DN: the distinguished name of the entry at the base of the namespace, and
STATE: the state of this record, indicating whether this is a currently valid namespace.

The server table (112) in the database (29) has one or more rows for each directory server. A row in this table indicates the network address to contact a directory server, as well as the authentication credentials to access that server. For example, if a directory server supports LDAP, then a row in this table will specify an IP address, the TCP port number, the distinguished name of an entry for the replication validator to bind as, and the password for binding as that distinguished name. The primary key of this table is the SERVER ID column. The columns of this table are:
SERVER ID: a unique identifier for the server,
PROTOCOL: an indication of the protocol, such as “ldap” for the Lightweight Directory Access Protocol or “ldaps” for the Lightweight Directory Access Protocol layered atop the Secure Sockets Layer,
ADDRESS: the network address and port number for the server,
BIND DN: the distinguished name as which the replication validator should authenticate to the server, and
CREDENTIALS: the authentication credentials, such as a password, to access the server.

For any given namespace, if there are multiple updatable directory servers, then it is possible that an update point in the set of update points and an observation point in the set of observation points might both indicate the same directory server. There may be a single row in the table if the same authentication credentials are suitable for both updates and searches performed against the directory server, but there may be two rows in the table if different authentication credentials are required.

For each namespace, the replication validator is configured with a set of one or more update points. For each update point, the replication validator is configured with the address of a directory server where update operations can be performed, and authentication credentials to authenticate to that directory server. The configured credentials must permit entries to be created and modified in the directory within that namespace. For each update point, the replication validator is further configured with a range for the generation of names of entries. The range is a specification of a lower and upper bound of a numeric identifier that is used in the name of an entry. One example of a range is a restriction that a value in the name of an entry used as a numeric identifier must be between the values 1000 and 1999.

There is one row for each update point in the update table (114) in the database (29). The primary key of this table is the SERVER ID column. The columns of this table are:
NAMESPACE ID: the unique identifier of a namespace, matching a value of the NAMESPACE ID column in the namespace table (110),
SERVER ID: the unique identifier of a directory server, matching a value of the SERVER ID column in the server table (112),
TEMPLATE ID: the unique identifier of an update template, matching a value of the TEMPLATE ID column in the template table (116), and
UPDATE RANGE: a specification for the range of numeric identifiers by which entries may be named, comprising two positive integers.

For each update point, the replication validator is configured with a template for a directory entry suitable for use in that namespace. The template specifies: the pattern of a legal name (for LDAP, a distinguished name) for an entry, in which the entry typically represents a person or a computer account, the attributes which must be present in such an entry, the attributes which may optionally be present, and whether names of entries generated using this template can be reused. The configuration for an attribute consists of an attribute type, and either: a specific value that must be present, an indication that a numeric value must be present in values of that attribute, an indication that the value must begin with a letter combination, such as “TEST”, or an indication that any string could be used as a value for the attribute. There is one row in the template table (116) in the database (29) for each update point. The primary key of this table is the TEMPLATE ID column. The columns of this table are:
TEMPLATE ID: a unique identifier for the row,
DN PATTERN: the pattern used to generate the distinguished name of an entry,
MANDATORY ATTRIBUTES: a set of configurations for mandatory attributes of entries constructed according to this template,
OPTIONAL ATTRIBUTES: a set of configurations for optional attributes of entries constructed according to this template, and
REUSE: a boolean indication of whether names can be reused.

For each namespace, the replication validator is configured with a set of one or more observation points. For each observation point, the replication validator is configured with the address of a directory server where read or search operations can be performed, and authentication credentials to authenticate to that directory server. The configured credentials must permit entries to be retrieved from the directory within that namespace. For each observation point, the replication validator is configured with a maximum waiting time. There is one row in the observation table (118) in the database (29) for each observation point. The primary key of this table is the SERVER ID column. The columns of this table are:
NAMESPACE ID: the unique identifier of the namespace,
SERVER ID: the unique identifier of the directory server, and
MAX WAIT TIME: the maximum waiting time, in seconds.

For each observation point, the replication validator is configured with a set of observation rules, one for each of the update points in the namespace. Each observation rule defines the mapping for the names generated at each update point into the equivalent distinguished name for the entry as it would appear on the server contacted via the observation point. When a metadirectory is part of the deployment, the mapping defines how the metadirectory transforms the name of an entry. The mapping is encoded as programming language procedure which performs a translation from an input string (the source name) to an output string (the name in the observation point directory server). Examples of programming language encodings include the bytecodes of the Java Programming Language virtual machine, the bytecodes of the .NET Common Language Runtime virtual machine, and the scripting language Perl. The mapping is absent for replication environments where no metadirectory is present, and the name does not change.

For each observation rule there is one row in the mapping table (120) in the database (29). The primary key of this table is the combination of the OBSERVATION SERVER ID and the UPDATE SERVER ID columns. The columns of this table are:
NAMESPACE ID: the unique identifier of the namespace,
OBSERVATION SERVER ID: the unique identifier of the directory server of the observation point,
UPDATE SERVER ID: the unique identifier of the directory server of the update point, and
OBSERVATION RULE: the mapping of the observation rule.

For each observation rule there is one row in the observation status table (122) in the database (29). The primary key of this table is the combination of the OBSERVATION SERVER ID and the UPDATE SERVER ID columns. The columns of this table are:
NAMESPACE ID: the unique identifier of the namespace,
OBSERVATION SERVER ID: the unique identifier of the directory server of the observation point,
UPDATE SERVER ID: the unique identifier of the directory server of the update point,
LAST SUCCESS DATE: the date and time of the last successful operation between this pair of servers,
LAST FAILURE DATE: the date and time of the last failure detected between this pair of servers, and
REPLICATION LATENCY: the time in milliseconds that it is estimated that a replication transfer takes to the directory server indicated by the OBSERVATION SERVER ID from the directory server indicated by the UPDATE SERVER ID.

For each observation point and for each update point, there is one row in the server status table (124) in the database (29). The primary key of this table is the SERVER ID column. The columns of this table are:
NAMESPACE ID: the unique identifier of the namespace,
SERVER ID: the unique identifier of the directory server,
LAST CONNECTION SUCCESS DATE: the date and time of the last successful connection to this directory server from the replication validator,
LAST CONNECTION FAILURE DATE: the date and time of the last failed connection to this directory server from the replication validator,
LAST OP SUCCESS DATE: the date and time of the last successful operation performed with this directory server from the replication validator, and
LAST OP FAILURE DATE: the date and time of the last failed operation attempted at this directory server by the replication validator.

The name table (126) has one row for each entry created in a directory server by the replication validator. The columns of this table are:
NAMESPACE ID: the unique identifier of the namespace,
SERVER ID: the unique identifier of the directory server where the entry was created,
DN: the name of the entry,
RANGE OFFSET: the number of the entry,
ENTRY CONTENTS: an encoding of the attributes of the entry, in a format such as the LDAP Data Interchange Format (LDIF) or the Directory Service Markup Language (DSML), and
ADD DATE: the date and time the entry was added to the directory server.

The administrator interface (37) is a software component that enables the administrator (31) to view the state of directory replication between the directory servers.

The metadirectory server (246) is a software component that synchronizes the contents of two or more directory servers with dissimilar replication protocols or directory structures.

The processing components of this invention can be implemented as software running on computer systems on an enterprise network.

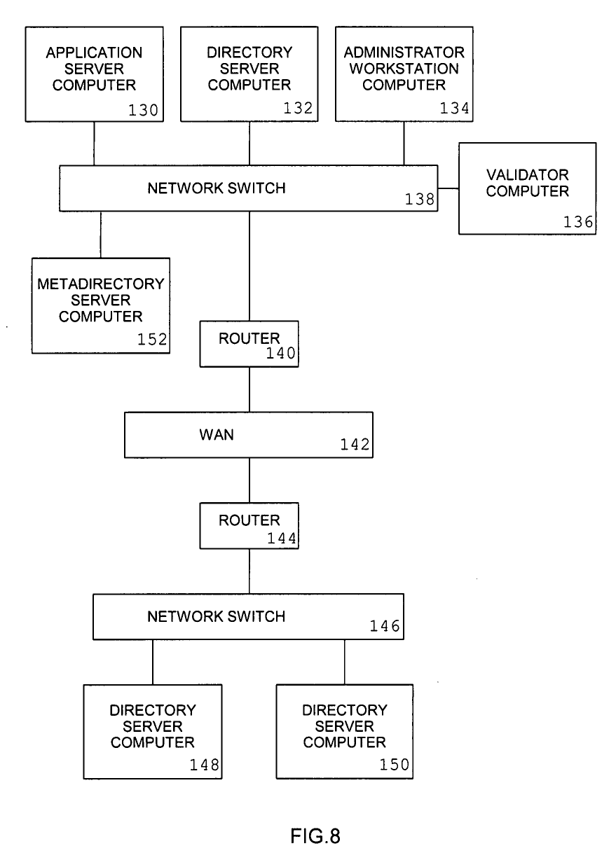

FIG. 8 illustrates an example enterprise network. This network consists of two local area networks, implemented by network switches (138 and 146), and interconnected by a wide area network (142). In this network, the directory client (11) can be implemented as a component of a software application running on an application server computer (130) The directory servers (10, 12, 14, 16) can be implemented as software running on directory server computers (134, 148, and 150). The administrator interface (37) can be implemented as software running on an administrator workstation computer (134). The replication validator (28) and database (29) can be implemented as software running on a validator computer (136). The metadirectory server (246) can be implemented as software running on a metadirectory server computer (152).

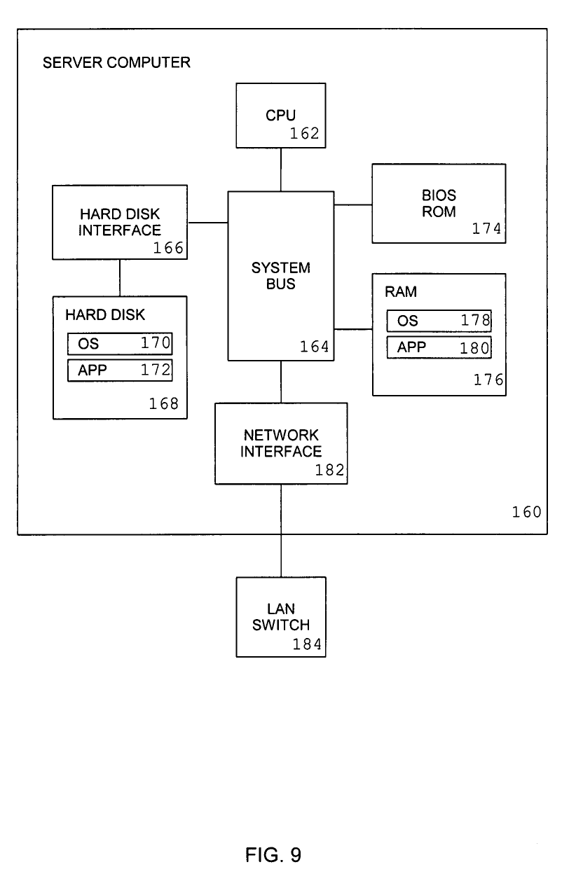

FIG. 9 illustrates the typical components of a server computer (160). Examples of server computers with these components include the application server computer (130), directory server computer (134, 148, 150), metadirectory server computer (152), and validator computer (136). Components of the computer include a CPU (162), a system bus (164), a hard disk interface (166), a hard disk (168), a BIOS ROM (174), random access memory (176), and a network interface (182). The network interface connects the computer to a local area network switch (184). The hard disk (168) stores the software and the persistent state of the operating system (170) and applications (172) installed on that computer. The random access memory (176) holds the executing software and transient state of the operating system (178) and applications (180).

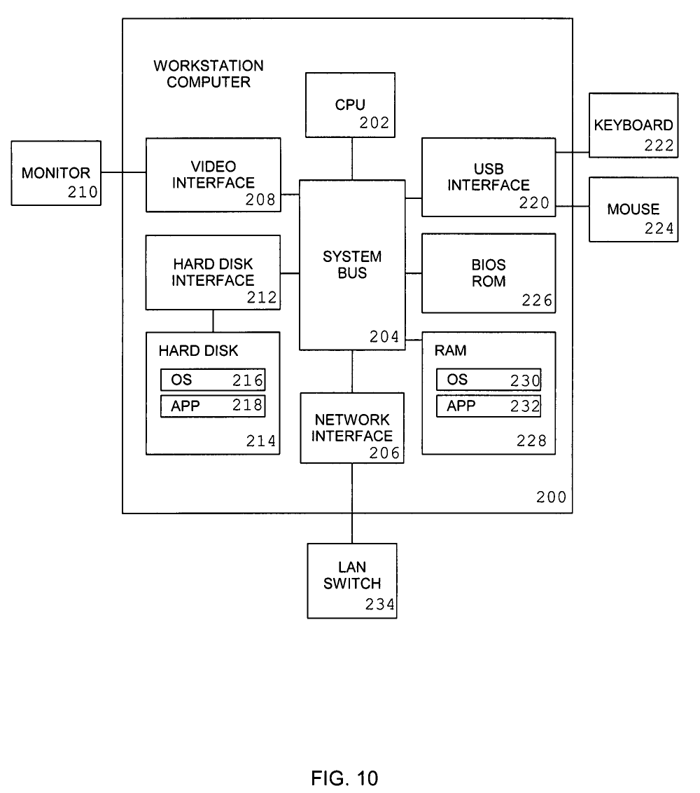

FIG. 10 illustrates the typical components of a workstation computer (200). An example of a workstation computer with these components is the administrator workstation computer (134). Components of the workstation computer include a CPU (202), a system bus (204), a video interface (208) to a monitor (210), a USB interface (220) to a keyboard (222) and mouse (224), a hard disk interface (212), a BIOS ROM (226), a network interface (206), and random access memory (228). The network interface (206) connects the computer to a local area network switch (234). The hard disk (214) stores the software and the persistent state of the operating system (216) and applications (218) installed on that computer. The random access memory (228) holds the executing software and transient state of the operating system (230) and applications (232).

### Operations

The replication validator comprises one or more threads of control, which may execute in parallel with each other. There are three kinds of threads: the primary thread of control, the processing thread, and the observing thread.

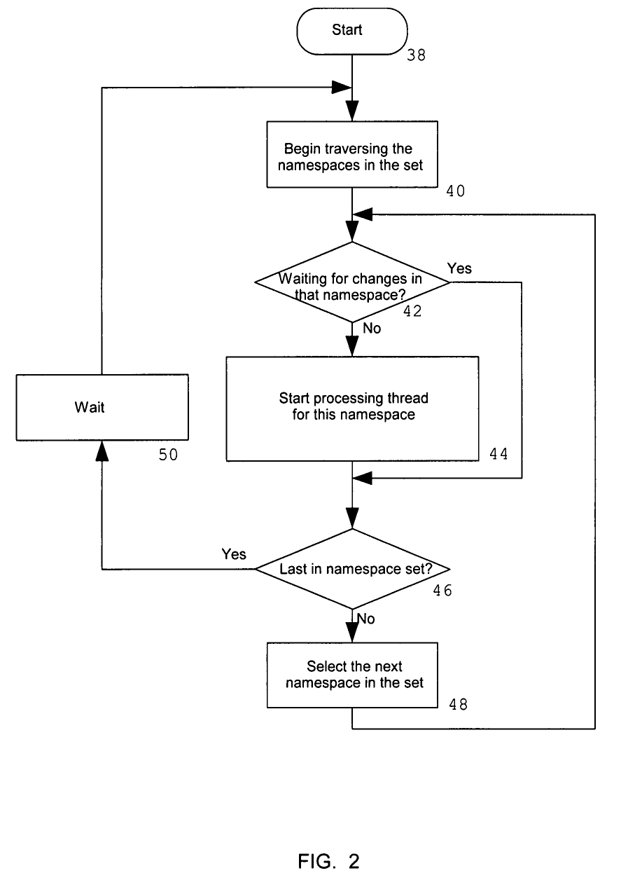

The behavior of the primary thread of control, of which there is exactly one present in a replication validator, is illustrated in the flowchart of FIG. 2.

At step 40, the thread will begin traversing the namespaces in the set of namespaces known to the replication validator. The thread will iterate through the rows of the namespace table (110) in which the value in the STATE column indicates that the namespace is currently valid. At step 42, the thread will determine if there is already a processing thread running for that namespace. If there is no processing thread already running for that namespace, then at step 44 the thread will start a new processing thread for that namespace. At step 46, the thread will check whether that namespace is the last in the set of namespaces. If that namespace is not the last namespace, then at step 48 the thread will loop to the next namespace in the set. Otherwise, at step 50 the thread will wait a predetermined number of seconds before continuing, in order to prevent the replication from consuming excessive processing and storage resources.

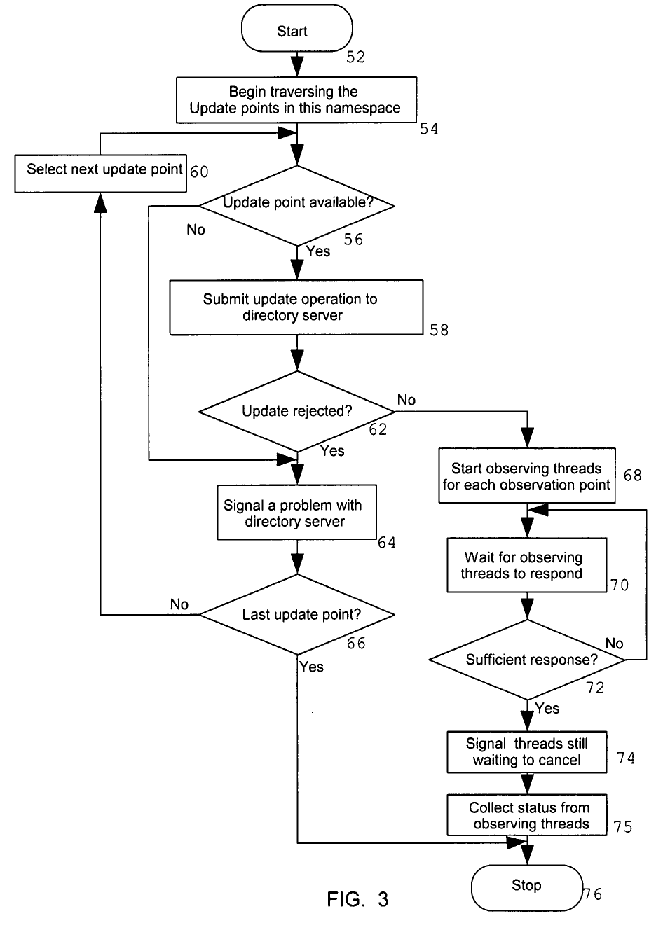

The behavior of the processing threads, of which there may be multiple threads of this kind executing concurrently within a replication validator, is illustrated in the flowchart of FIG. 3.

At step 52, a processing thread is started by the primary thread of control, and will be provided with the unique identifier of a namespace.

At step 54, the processing thread will begin traversing the update points in the namespace. The thread will first select rows from the update table (114) in which the value in the NAMESPACE ID column matches the unique identifier of a namespace provided to the thread. The thread will then order these rows according to a sorting algorithm. The thread will join the selected rows from the update table with rows from the server status table (124) in which the value in the SERVER ID column of the update table matches the value in the SERVER ID column of the server status table, and the value in the NAMESPACE ID column of the update table matches the value in the NAMESPACE ID column of the server status table. The thread will sort the selected rows from the update table based on the values of the LAST CONNECTION SUCCESS DATE, LAST CONNECTION FAILURE DATE such that:
the rows selected from the update table for which there is no corresponding row in the server status table appear first in the sorted set,
the rows selected from the update table for which the value of the LAST CONNECTION SUCCESS DATE column in the row from the server status table is null appear second in the sorted set, and are sorted in ascending order of the value of the LAST CONNECTION FAILURE DATE, and
the rows selected from the update table for which the value of the LAST CONNECTION SUCCESS DATE column in the row from the server status table is not null appear third in the sorted set, and are sorted in ascending order of the value of the LAST CONNECTION SUCCESS DATE.

At step 56, the processing thread will obtain the directory server network address and authentication credentials, by retrieving the row from the server table (112) in which the value of the SERVER ID column matches that of SERVER ID column in the row retrieved from the update table. The processing thread will attempt to establish a transport connection to that directory server and authenticate to that directory server using the credentials retrieved from the server table. If the directory server is unavailable or rejects the authentication credentials, then the thread will continue at step 64.

Otherwise, if the connection is established to the directory server and the directory server accepts the authentication credentials, then at step 58 the thread will construct an update operation to send to the directory server over that connection. The thread will retrieve the row from the template table (116) in which the value in the TEMPLATE ID column matches the value in the TEMPLATE ID column of the row from the update table. The thread will retrieve the rows, if any are present, from the name table (126) in which the values of the NAMESPACE ID and SERVER ID columns match those of the row from the update table. Based on the value of the UPDATE RANGE column from the row from the update table, the row retrieved from the template table, and the rows retrieved from the name table, the thread will determine whether to generate an add operation, a delete operation, or a modify operation. If the value in the REUSE column in the row retrieved from the template table is set to FALSE, and there are fewer rows retrieved from the name table than there are numbers in the UPDATE RANGE, then the operation to be generated is an add operation. If the value in the REUSE column in the row retrieved from the template table is set to FALSE, and as many rows were retrieved from the name table as there are numbers in the UPDATE RANGE, then the operation to be generated is a modify operation. If the value in the REUSE column in the row retrieved from the template table is set to TRUE, and zero rows were retrieved from the name table, then the operation to be generated is an add operation. If the value in the REUSE column in the row retrieved from the template table is set to TRUE, and as many rows were retrieved from the name table as there are numbers in the UPDATE RANGE, then the thread will randomly select whether to generate a modify operation or to generate a delete operation. If the value in the REUSE column in the row retrieved from the template table is set to TRUE, and the number of rows retrieved from the name table was at least one but less than there are numbers in the UPDATE RANGE, then the thread will randomly select whether to generate an add operation, to generate a modify operation, or to generate a delete operation.

If the thread selects to generate an add operation, then the thread will construct a new entry. The thread will select a range offset within the range of the UPDATE RANGE for which there is not already a row retrieved from the name table with a value in the RANGE OFFSET column of that same value. The thread will generate the distinguished name of the entry to be added by substituting the range offset into the value of the DN PATTERN column from the row retrieved from the template table in the previous step. The thread will generate the attributes of the entry based on the values of the MANDATORY ATTRIBUTES and OPTIONAL ATTRIBUTES columns of the row from the template table. For each mandatory attribute, the thread will create one or more values as specified by the value of the MANDATORY ATTRIBUTES column of the row from the template table. For each optional attribute, the thread will create one value. The thread will add a new row to the name table (126) in which the value of the NAMESPACE ID column is the unique identifier of the namespace, the value of the SERVER ID column is the unique identifier of the directory server, the value of the DN column is the distinguished name of the entry, the value of the RANGE OFFSET column is the range offset, the value of the ENTRY CONTENTS column is a string encoding of the attributes of the entry, and the value of the ADD DATE column is the current date and time. The thread will then send an Add request to the directory server containing the generated distinguished name and attributes.

If the thread selects to generate a modify operation, the thread will select a random row from the rows retrieved from the name table in the previous step. The thread will replace a non-distinguished (not forming part of the entry's distinguished name) optional attribute with a new value. The thread will update that row in the name table (126) by changing the value of the ENTRY CONTENTS column to the string encoding of the revised attributes of the entry. The thread will then send a Modify request to the directory server, in which the distinguished name is the value of the DN column of that row, and the modification consists of a single element, a replace operation with the revised attribute.

If the thread selects to generate a delete operation, the thread will select a random row from the rows retrieved from the name table in the previous step. The thread will send a Delete request to the directory server in which the distinguished name is the value of the DN column in the row selected from the name table.

At step 62, the processing thread will wait for a response from the directory server to the operation submitted in step 58. If the response indicated an error returned from the directory server and the operation submitted to the directory was an add operation or a modify operation, then the processing thread will remove the row from the name table in which the value in the NAMESPACE ID column is the unique identifier of the namespace, the value in the SERVER ID column is the unique identifier of the directory server, and the value in the DN column is the distinguished name of the entry that was added or modified. If the connection was closed, the thread timed out waiting for a response, or the result code in the response indicated an error, then processing will continue at step 64. If the directory server returned a result code of success, and the operation sent to the directory server was a delete, then the processing thread will remove the row from the name table in which the value in the NAMESPACE ID column is the unique identifier of the namespace, the value in the SERVER ID column is the unique identifier of the directory server, and the value in the DN column is the distinguished name of the entry that was deleted. If the directory server returned a result code of success, then processing will continue at step 68.

At step 64, the processing thread will indicate to the administrator (31) that there is a problem with the directory server. If a connection was established by this thread to a directory server, the thread will unbind from the directory server and the connection will be closed.

The thread will update the server status table (124). If there is no row in the table in which the value of the NAMESPACE ID column matches the unique identifier of the namespace and the value of the SERVER ID column matches the unique identifier of the directory server, then the thread will add a row to the server status table, in which the value of the NAMESPACE ID column is the unique identifier of the namespace and the value of the SERVER ID column is the unique identifier of the directory server. If a connection was established, the value of LAST CONNECTION SUCCESS DATE column and the value of the LAST OP FAILURE DATE column are set to the current date and time in the row being added, and the values of the LAST CONNECTION FAILURE DATE column and the LAST OP SUCCESS DATE column are set to null. If a connection was not established, the values of the LAST CONNECTION SUCCESS DATE column, the LAST OP SUCCESS DATE column, and the LAST OP FAILURE DATE column are set to null in the row being added, and the value of LAST CONNECTION FAILURE DATE column is set to the current date and time. Otherwise, if a row was found in the server status table, the thread will update the row in the server status table in which a value of the NAMESPACE ID column matches the unique identifier of the namespace and the value of the SERVER ID column matches the unique identifier of the directory server. If a connection could be established, the value of the LAST CONNECTION SUCCESS DATE column and the value of the LAST OP FAILURE DATE column in the row being updated are set to the current date and time, otherwise if a connection could not be established, the value of the LAST CONNECTION FAILURE DATE is set to the current date and time.

At step 66, the thread will determine if the row from the sorted order of rows selected from the update table is the last row. If it is not the last row, then at step 60 the thread will loop with the next row in the sorted list. Otherwise, the thread will exit.

At step 68, the thread will have submitted the update operation to the directory server update point, and will start observing threads for each observation point. First, the thread will unbind and close the connection to the directory server. Then, the thread will retrieve from the observation table (118) rows in which the value of the NAMESPACE ID column matches the unique identifier of the namespace. For each row, the thread will create a new observation thread, and provide to the observation thread the namespace identifier, the unique identifier of the server to which the update was submitted, the row from the observation table, and the update submitted to the directory server.

At step 70, the processing thread will wait for observation threads that it created at step 68 to complete, or for a waiting time limit to be reached.

At step 72, the thread will determine the number of observation threads that have completed and if the waiting time limit has been reached. If the waiting time limit has not been reached, or some of the observation threads which have been started have not yet completed, then the thread will loop to step 70. This loop will ensure that under normal operations, the processing thread will wait until a substantial majority of observation point servers have reported before another change is submitted to an update point server.

At step 74, a processing thread will signal to the remaining observation threads that were started at step 68 to cancel.

At step 75, a processing thread will collect the status from the observation threads that were not canceled. The status information incorporates the unique identifier of the observation directory server, whether the server was available, and whether the replicated change was present. If there is a row in the observation status table (122) in which the value of the NAMESPACE ID column is the unique identifier of the namespace, the value of the OBSERVATION SERVER ID column is the unique identifier of the observation directory server, and the value of the UPDATE SERVER ID column is the unique identifier of the server to which the processing thread submitted an update, then the processing thread will update that row. If the observation directory server was available and the replicated change was present, then the processing thread will set in the update to the row the value of the LAST SUCCESS DATE column to the current date and time, otherwise the processing thread will set in the update to the row the value of the LAST FAILURE DATE column to the current date and time. Otherwise, the processing thread will insert a row in the observation status table in which the value of the NAMESPACE ID column is the unique identifier of the namespace, the value of the OBSERVATION SERVER ID column is the unique identifier of the observation directory server and the value of the UPDATE SERVER ID column is the unique identifier of the server to which the processing thread submitted an update. If the observation directory server was available and the replicated change was present, the value of the LAST SUCCESS DATE column in the row being inserted is set to the current date and time, and the LAST FAILURE DATE column to NULL, otherwise the value of the LAST FAILURE DATE column in the row being inserted is set to the current date and time, and the LAST SUCCESS DATE column to NULL.

If there is a row in the server status table (124) in which the value of the NAMESPACE ID column is the unique identifier of the namespace and the value of the SERVER ID column is the unique identifier of the observation directory server, then the processing thread will update that row. If the observation directory server was not available, then the value of the LAST CONNECTION FAILURE DATE column is set to the current date and time, otherwise then the value of the LAST CONNECTION SUCCESS DATE is set to the current date and time. If the observation directory server was available, and the replicated change was present, then the value of the LAST OP SUCCESS DATE column is set to the current date and time, otherwise, if the observation directory server was available, but the replicated change was not present, then the value of the LAST OP FAILURE DATE is set to the current date and time. Otherwise, if a row was not found in the server status table, the processing thread will insert a row to the server status table in which the value of the NAMESPACE ID column is the unique identifier of the namespace, the value of the SERVER ID column is the unique identifier of the observation directory server, and the REPLICATION LATENCY column is NULL. If the observation directory server was not available, then the value of the LAST CONNECTION FAILURE DATE column in the row being inserted is set to the current date and time, otherwise the value of the LAST CONNECTION SUCCESS DATE column in the row being inserted is set to the current date and time. If the observation directory server was available and the replicated change was present, then the value of the LAST OP SUCCESS DATE column in the row being inserted is set to the current date and time, otherwise if the observation directory server was available but the replicated change was not present, the value of the LAST OP FAILURE DATE column in the row is set to the current date and time.

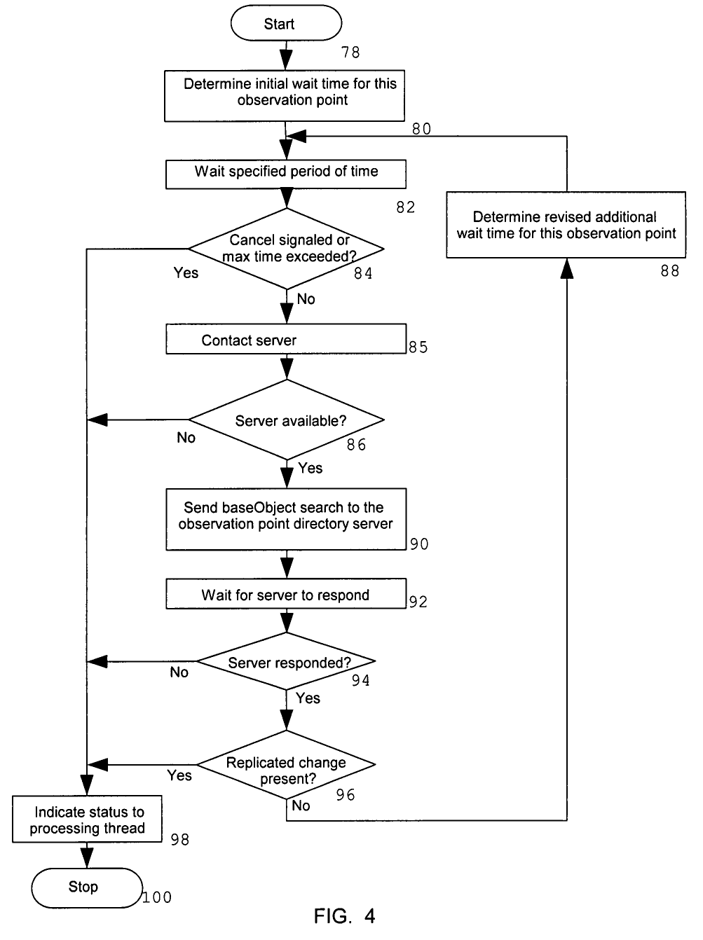

The behavior of the observing threads, of which there may be multiple threads of this kind executing concurrently in the replication validator, is illustrated in the flowchart of FIG. 4.

At step 78, an observation thread is started by a processing thread, and will be provided with the unique identifier of a namespace, the unique identifier of the server to which the processing thread submitted an update, the row from the observation table for this observation thread, and the update submitted by the processing thread to the directory server. The thread will use the value of the SERVER ID column in the row from the observation table as the unique identifier of the observation directory server.

At step 80, the thread will determine the initial wait time for the observation point. The initial wait time will be an estimate of the time delay after a change has been submitted to the update point before the change is processed by the observation point. The thread will search for a row in the observation status table (122) in which the value of the NAMESPACE ID column is the unique identifier of the namespace, the value of the OBSERVATION SERVER ID column is the unique identifier of the observation directory server, and the value of the UPDATE SERVER ID column is the unique identifier of the directory server to which the update was submitted. If a row is present, and the value in the REPLICATION LATENCY column in that row is not NULL, then the value from the REPLICATION LATENCY column is the initial wait time. Otherwise, if a row was not found, or the value in the REPLICATION LATENCY column is NULL, then a default minimum value, such as one second (1000 milliseconds), is used.

At step 82, the thread will wait the specified period of time, or until it has received a cancel signal from the processing thread that started it, or until the total waiting time performed by this thread exceeds the maximum waiting time. The maximum waiting time is obtained from the value of the MAX WAIT TIME column of the row obtained from the observation table (118).

At step 84, the thread will determine whether the maximum wait time for this observation point has been reached, or the thread has been canceled by the processing thread that started it. If the thread has reached the maximum wait time or has been canceled, then processing will continue at step 98.

At step 85, if the thread does not already have a connection to the directory server, the thread will establish a transport connection to the directory server, and authenticate to the directory server. The thread will obtain the parameters for establishing the connection by selecting a row from the server table (112) in which the value in the SERVER ID column matches the value of the SERVER ID column from the row obtained from the observation table (118).

At step 86, the thread will check if a connection is available to the directory server. If a connection could not be established, then the thread will continue at step 98.

At step 90, the thread will send a search request to the directory server over this connection. The scope of the search will be baseObject. The distinguished name of the search is by default the distinguished name of the update performed by the processing thread. However, if there is a row of the mapping table (120) in which the value of the NAMESPACE ID column is the unique identifier of the namespace, the value of the OBSERVATION SERVER ID column is the unique identifier of the observation directory server, and the value of the UPDATE SERVER ID column is the unique identifier of the directory server where the update was submitted. If a row is present, the rule specified by the value of the OBSERVATION RULE column in that row is used to transform the distinguished name.

At step 92, the thread will wait a specified period of time for the directory server to respond or for the thread to receive a cancel signal from the processing thread that started this thread.

At step 94, the thread will check whether the server has responded. If the server did not respond, or if the thread received a cancel signal from the processing thread that started it, then the thread will continue at step 98.

At step 96, the thread will check whether the server's response indicated that the replicated change was present. If the operation that was sent to the update point directory server was an add operation, then the replicated change will be present if the search returns an entry. If the operation that was sent to the update point directory server was a modify operation, then the replicated change will be present if the search operation returns an entry with the attributes that were included in the modify operation. If the operation that was sent to the update point directory server was a delete operation, then the replicated change will be present if the search operation fails to return an entry, indicating that the entry is no longer present.

If the replicated change is not yet present, then at step 88 the thread will determine additional wait time for this observation point, and loop back to step 82. To determine the additional wait time, the thread will first check if there is a row in the observation status table (122) in which the value in the NAMESPACE ID column is the unique identifier of the namespace, the value in the OBSERVATION SERVER ID column is the unique identifier of the observation directory server, and the value in the UPDATE SERVER ID column is the unique identifier of the directory server to which the update was submitted by the processing thread. If a row is found, then that row is updated to replace the value in the REPLICATION LATENCY column with the wait time last used at step 82. If a row is not found, then a row is added to the table in which the value in the NAMESPACE ID column is the unique identifier of the namespace, the value in the OBSERVATION SERVER ID column is the unique identifier of the observation directory server, the value in the UPDATE SERVER ID column is the unique identifier of the directory server to which the update was submitted by the processing thread, and the value in the REPLICATION LATENCY column is the wait time last used at step 82. The additional wait time is the wait time last used at step 82 multiplied by a constant value, such as 1.1.

At step 98, the thread will return a status response to the processing thread that had started it. The status information incorporates the unique identifier of the observation directory server, whether that directory server was available, and whether the replicated change was present. If the thread was able to establish a connection to the directory server, then the thread will then disconnect from the directory server.

Finally, at step 100, the thread will exit.

### CONCLUSIONS

Many different embodiments of this invention may be constructed without departing from the scope of this invention. While this invention is described with reference to various implementations and exploitations, and in particular with respect to replication monitoring systems, it will be understood that these embodiments are illustrative and that the scope of the invention is not limited to them.

What is claimed is:

1. A method of validating replication status between an updatable directory server and an observation directory server in a network environment, said method comprising:
(a) submitting an update operation to said updatable directory server,
(b) submitting a search operation to said observation directory server, and
(c) comparing the result of said update operation and said search operation to validate that said update operation was replicated to said observation directory server.

2. The method of claim 1, wherein said update operation is submitted over a transport connection using a lightweight directory access protocol.

3. The method of claim 1, wherein said search operation is submitted over a transport connection using a lightweight directory access protocol.

4. The method of claim 1, wherein said search operation comprises a distinguished name that has been transformed from the distinguished name of said update operation using a mapping function.

5. The method of claim 1, wherein said update operation is repeatedly submitted to said updatable directory server on a periodic basis.

6. A system for validating replication status between directory servers in a network environment, comprising:
(a) an updatable directory server;
(b) an observation directory server, and
(c) a validator component which submits an update operation to said updatable directory server and a search operation to said observation directory server, and compares the results of said update operation and said search operation.

7. The system of claim 6, wherein said updatable directory server, said observation directory server, and said validator component are implemented as software running on a general-purpose computer system.

8. The system of claim 6, wherein said update operation is submitted to said updatable directory server using a lightweight directory access protocol over a transport connection.

9. The system of claim 6, wherein said search operation is submitted to said observation directory server using a lightweight directory access protocol over a transport connection.

10. The system of claim 6, further comprising:
a database component.

11. The system of claim 10, wherein said database component is implemented as a relational database.

12. A computer program product within a computer usable medium for validating directory replication, said computer program product comprising:
(a) instructions for submitting an update operation to an updatable directory server,
(b) instructions for submitting a search operation to an observation directory server,
(c) instructions for comparing the result of said update operation and said search operation to determine if said update operation was replicated to said observation directory server.

13. The computer program product of claim 12, wherein said instructions for submitting a search operation to an observation directory server comprises transforming the distinguished name of said update operation using a mapping function.
